(19) United States
(12) Patent Application Publication
(10) Pub. No.: US 2010/0126065 A1
(43) Pub. Date: May 27, 2010

(54) METHOD OF IMPROVING GERMINATION OF PLANT SEED

(75) Inventors: Ryo Nishimura, Niihama- shi (JP); Yasutaka Soeda, Niihama- shi (JP)

Correspondence Address: BIRCH STEWART KOLASCH & BIRCH, PO BOX 747, FALLS CHURCH, VA, 22040-0747, US

(73) Assignee: Sumika Agrotech Company, Limited, Osaka-shi (JP)

(21) Appl. No.: 11/988,460

(22) PCT Filed: Jul. 11, 2006
(86) PCT No.: PCT/JP2006/314134

§ 371 Date: Jun. 27, 2008

(30) Foreign Application Priority Data
Jul. 21, 2005 (JP) 2005-210863

(51) Int. Cl. A01C 1/00

(52) U.S. Cl. 47/58.1 SE

(57) ABSTRACT

A method of improving germination of plant seeds, comprising a low temperature contact process of allowing plant seeds to contact plant growth regulating agents and water at a temperature lower than 10° C. wherein the treatment time in the low temperature contact process is shorter than 24 hours, and a method of improving germination of plant seeds, comprising (1) a low temperature contact process of allowing plant seeds to contact plant growth regulating agents and water at a temperature lower than 10° C., and (2) a low temperature preservation process of preserving, after the first process, the plant seeds at a temperature lower than 10° C., wherein the sum of the treatment time in the low temperature contact process and the treatment time in the low temperature preservation process is shorter than 24 hours; and the like.

### TECHNICAL FIELD

The present invention relates to a method of improving germination of plant seeds, and the like

### BACKGROUND ART

For help in improvement of the quality of crops and improvement of farm operation, methods of improving germination of plant seeds are described in Japanese Patent Application Laid-Open (JP-A) Nos. 8-66108 and 2004-129614, and the like.

### DISCLOSURE OF THE INVENTION

Under such conditions, there is desired development of a method of improving germination of plant seeds which is different from conventionally known methods of improving germination of plant seeds, for spreading choice on usable methods and enhancing production efficiency.

The present inventors have intensively studied under such conditions, and resultantly found that a combination of a specific technical processes is useful for improvement in germination of plant seeds, leading to completion of the present invention.

That is, the present invention provides

[1] a method of improving germination of plant seeds, comprising a low temperature contact process of allowing plant seeds to contact plant growth regulating agents and water at a temperature lower than 10° C. wherein the treatment time in the low temperature contact process is shorter than 24 hours (hereinafter, referred to as first germination improving method of the present invention, in some case);

[2] a method of improving germination of plant seeds, comprising

(1) a low temperature contact process of allowing a plant seeds to contact plant growth regulating agents and water at a temperature lower than 10° C., and

(2) a low temperature preservation process of preserving, after the contact process, the plant seeds at a temperature lower than 10° C.,

wherein the sum of the treatment time in the low temperature contact process and the treatment time in the low temperature preservation process is shorter than 24 hours (hereinafter, referred to as second germination improving method of the present invention, in some case);

[3] the method according to [2], wherein regarding the proportion of the treatment time in the low temperature contact process and the treatment time in the low temperature preservation process, the value of the latter is less than 2 with respect to a value of the former of 1;

[4] the method according to any one of [1] to [3], wherein the plant growth regulating agents are auxin, cytokinin, gibberellin, abscisic acid or ethylene generating agent;

[5] the method according to any one of [1] to [4], wherein the low temperature contact process is a process of allowing plant seeds to contact plant growth regulating agents and water while aerating;

[6] plant seeds which have been subjected to the method as described in any one of [1] to [5];

[7] a method of producing a dry plant seed maintaining excellent germination rate, comprising

(1) a low temperature contact process of allowing plant seeds to contact plant growth regulating agents and water at a temperature lower than 10° C., and

(2) a drying process of drying, after the contact process, the plant seeds to a seed water content of 10% or less,

wherein the treatment time in the low temperature contact process is shorter than 24 hours (hereinafter, referred to as first production method of the present invention, in some case);

[8] a method of producing dry plant seeds maintaining excellent germination rate, comprising

(1) a low temperature contact process of allowing plant seeds to contact plant growth regulating agents and water at a temperature lower than 10° C.,

(2) a low temperature preservation process of preserving, after the contact process, the plant seeds at a temperature lower than 10° C., and

(3) a drying process of drying, after the preservation process, the plant seeds to a seed water content of 10% or less,

wherein the sum of the treatment time in the low temperature contact process and the treatment time in the low temperature preservation process is shorter than 24 hours;

[9] the method according to [8], wherein regarding the proportion of the treatment time in the low temperature contact process and the treatment time in the low temperature preservation process, the value of the latter is less than 2 with respect to a value of the former of 1;

[10] the method according to any one of [7] to [9], wherein the low temperature contact process is a process of allowing plant seeds to contact plant growth regulating agents and water while aerating;

[11] dry plant seeds which have been produced by the method according to any one of [7] to [10] (hereinafter, referred to as dry plant seeds of the present invention, in some case);

[12] plants obtained by germination of the plant seeds as described in [6] or [11], and further raising seedling thereof (hereinafter, referred to as plant of the present invention, in some case); and the like.

Examples of plant seeds as subject matters in the present invention include seeds of vegetables such as asteraceous crops such as lettuce, burdock and the like, liliaceae crops such as Welsh onion, onion, Chinese chive and the like, cruciferae such as cabbage, Chinese cabbage, radish and the like, solanaceous crops such as eggplant (Solanum melongena), tomato, Solanum torvum, pepper and the like, umbelliferous crops such as carrot, celery, parsley and the like, chenopodiaceous crops such as spinach and the like, cucurbitaceous crops such as cucumber, melon and the like, gramineous crops, and the like; seeds of flowers such as Eustoma, pansy, begonia and the like; seeds of meadow grasses such as guinea grass, rose grass and the like; seeds of cereals such as rice, barley, corn and the like; seeds of woods such as eucalyptus and the like; seeds of edible or industrial crops such as leguminous crops such as soybean, pea and the like, asteraceous crops such as sunflower and the like, polygonaceous crops such as buckwheat and the like, gramineous crops such as edible Japanese millet and the like.

The first germination improving method of the present invention is characterized in by comprising a low temperature contact process of allowing plant seeds to contact plant growth regulating agents and water at a temperature lower than 10° C. wherein the treatment time in the low temperature contact process is shorter than 24 hours. The second germination improving method of the present invention is characterized in by comprising (1) a low temperature contact process of allowing plant seeds to contact a plant growth regulating agent and water at a temperature lower than 10° C., and (2) a low temperature preservation process of preserving, after the contact process, the plant seed at a temperature lower than 10° C., wherein the sum of the treatment time in the low temperature contact process and the treatment time in the low temperature preservation process is shorter than 24 hours.

“Plant growth regulating agents” to be used in the low temperature contact process of the first germination improving method of the present invention and the second germination improving method of the present invention means plant growing regulation-active compounds, precursors thereof or formulations thereof, and examples thereof include auxin, cytokinin, gibberellin, abscisic acid, ethylene, ethylene generating agent and the like. Preferably mentioned are cytokinin, gibberellin, ethylene, Ethrel 10 (formulation containing ethephone in a proportion of 10% as an active ingredient) as an ethylene generating agent, and the like.

As “plant growth regulating agent and water” to be used in the low temperature contact process of the first germination improving method of the present invention and the second germination improving method of the present invention, there is used agents prepared in the form of an aqueous solution containing plant growth regulating agents by dissolution in water of the plant growth regulating agents at a concentration, for example, of 0.01 to 1% (w/v), more specifically, in the case of cytokinin, of 0.5 to 50 ppm (w/v), more preferably 1 to 20 ppm; in the case of gibberellin, of 0.1 to 1000 ppm (w/v), more preferably 0.1 to 400 ppm; in the case of ethylene, of 0.1 to 200 ppm (w/v), more preferably 1 to 100 ppm; and in the case of ethephone, of 1 to 5000 ppm (w/v), more preferably 200 to 4000 ppm; each in terms of active ingredient concentration. pH in this aqueous solution varies depending on the kind of the plant seed, the kind of the plant growth regulating agents to be contained, the concentration thereof, and the like, and for example, is in the range of about 1.5 to about 10.

The above-described “plant growth regulating agent and water” may further contain an osmotic pressure regulating agent. The “osmotic pressure regulating agent” which can be herein used may be that which is usually used in a water absorption treatment for germination of a plant seed, and specific examples thereof include potassium nitrate, potassium phosphate, polyethylene glycol, mannitol and the like. As the osmotic pressure of the “plant growth regulating agent and water” to be used in the low temperature contact process of the first germination improving method of the present invention and the second germination improving method of the present invention, for example, osmotic pressures of about −1.5 MPa or more and about less than −0.2 MPa are preferably mentioned. Here, the osmotic pressure in the case of use of a polymer such as polyethylene glycol and the like as the “osmotic pressure regulating agent” may be calculated, for example, according to the following formula:

Ψ(bar)=−(1.18×10⁻²)C−(1.18×10⁻⁴)C²+(2.67×10⁻⁴)CT+(8.39×10⁻⁷)C²T

showing the relation between the weight (g) of a solute per kg of water, the centigrade temperature T and the osmotic pressure Ψ (bar), which has been clarified in the study (Plant Physiol Vol. 51: 914-916, 1973) of BURLYN E. MICHEL, et al, while hypothesizing the liquid temperature T being 15° C. unless otherwise stated. On the other hand, the osmotic pressure in the case of use of potassium nitrate and the like which is not a polymer as the “osmotic pressure regulating agent” may be calculated, for example, according to the following Van' t Hoff formula:

PV=nRT (P: osmotic pressure, n: mol number of solute, V: volume of solution, T: absolute temperature, R: gas constant), while hypothesizing the temperature being 15° C. unless otherwise stated.

The above-described “plant growth regulating agent and water” may contain bactericidal compounds and/or fungicides such as thiuram, captan and the like.

As the method of allowing plant seeds to contact plant growth regulating agents and water at a temperature lower than 10° C. in the low temperature contact process of the first germination improving method of the present invention and the second germination improving method of the present invention, mentioned are, for example, (1) a method of immersing plant seeds in an aqueous solution containing plant growth regulating agents for about 0.3 hours to less than about 24 hours at lower than 10° C., (2) a method of adding an aqueous solution containing a plant growth regulating agent to a plant seed at lower than 10° C., and allowing the solution to stand for about 0.3 hours to less than about 24 hours, (3) a method of allowing an aqueous solution containing plant growth regulating agents to be absorbed in a gel or porous carrier and the like, then, allowing plant seeds to contact the carrier and the like for about 0.3 hours to less than about 24 hours at lower than 10° C.; and the like.

The low temperature contact process of the first germination improving method of the present invention and the second germination improving method of the present invention is carried out at a temperature of lower than 10° C., and usually, at a temperature of higher than 0° C. and lower than 10° C.

In the low temperature contact process of the first germination improving method of the present invention and the second germination improving method of the present invention, it is preferable to allow plant seeds to contact the above-described aqueous solution composed of plant growth regulating agents and water while aerating. The quantity of air to be fed may be, for example, about 0.02 liter/min to about 20 liter/min per liter of seeds.

In the low temperature preservation process of the second germination improving method of the present invention, the above-described plant seeds are preserved at a temperature of lower than 10° C. after the above-described low temperature contact process.

The low temperature preservation process of the second germination improving method of the present invention is carried out at a temperature of lower than 10° C., and usually, at a temperature of higher than 0° C. and lower than 10° C.

Regarding the proportion of the treatment time in the low temperature contact process of the second germination improving method of the present invention and the treatment time in the low temperature preservation process of the second germination improving method of the present invention, the value of the latter is preferably less than 2 with respect to a value of the former of 1.

The first production method of the present invention is characterized by comprising

(1) a low temperature contact process of allowing plant seeds to contact plant growth regulating agents and water at a temperature lower than 10° C., and

(2) a drying process of drying, after the contact process, the plant seeds to a seed water content of 10% or less,

wherein the treatment time in the low temperature contact process is shorter than 24 hours.

The second production method of the present invention is characterized by comprising

(1) a low temperature contact process of allowing plant seeds to contact plant growth regulating agents and water at a temperature lower than 10° C.,

(2) a low temperature preservation process of preserving, after the contact process, the plant seeds at a temperature lower than 10° C., and

(3) a drying process of drying, after the preservation process, the plant seeds to a seed water content of 10% or less,

wherein the sum of the treatment time in the low temperature contact process and the treatment time in the low temperature preservation process is shorter than 24 hours.

The low temperature contact process and the low temperature preservation process of the first production method of the present invention and the second production method of the present invention may advantageously be carried out in the same manner as for the low temperature contact process and the low temperature preservation process of the germination improving method of the present invention.

As the method of drying plant seeds to a seed water content of 10% or less in the drying process of the first production method of the present invention and the second production method of the present invention, there is mentioned, for example, a method in which the plant seeds after completion of the contact process of the first production method of the present invention and the preservation process of the second production method of the present invention are dried for about 0.5 hours to about 24 hours while dehumidifying to a relative humidity of about 50% or less and/or supplying air of about 15° C. to about 60° C., preferably about 20° C. to about 50° C. The supply quantity of air in this case is, for example, in the range of about 0.2 liter/min to about 5000 liter/min, per liter of seeds. For avoiding damage of seeds in the drying process as far as possible, it is desirable to maintain the seed temperature at about 10° C. to about 35° C.

As the method of drying plant seeds to a seed water content of 10% or less in the drying process of the first production method of the present invention and the second production method of the present invention, there is also mentioned a method in which a plant seeds are dried to a seed water content of about 20% under the above-described conditions, then, the plant seeds are coated and/or pelletized by an ordinary method, and the coated and/or pelletized plant seeds are further dried under the above-described conditions.

Here, “seed water content” indicates percentage of water weight occupying the raw weight of plant seeds. The water content can be measured by a method described in “Shubyo Tokuhon (seed and seedling reader)” (issued by Japan Seed Trade Association, 2002). That is, seeds are placed in a weighing bottle of known weight (A) and the weight (B) of the weighing bottle containing seeds is measured, then, dried at 105° C. for 16 hours while keeping the cap open. After drying, the weighing bottle was immediately capped and cooled to room temperature, and the weight (C) of the weighing bottle including seeds is measured. The seed water content is represented by (B−C)/(B−A)×100(%).

Thus performing the first germination improving method of the present invention or the second germination improving method of the present invention on plant seeds, further performing the drying process, (dried) plant seeds maintaining excellent germination rate can be produced. The produced plant seeds can also be coated and/or pelletized, if necessary.

Further, it may be permissible that the plant seeds subjected to the first germination improving method of the present invention or the second germination improving method of the present invention, or the dried plant seeds produced by the first production method of the present invention or the second production method of the present invention, are sown by a usual method, and raising seedling thereof is carried out using a usual seedling raising method, performing cultivation of a plant.

When the plant seeds subjected to the first germination improving method of the present invention or the second germination improving method of the present invention, or the dried plant seeds produced by the first production method of the present invention or the second production method of the present invention are required to germinate prior to sowing, a usual water absorption treatment operation may be advantageously carried out on these plant seeds. As the water absorption method, there are mentioned, for example, a method in which water in an amount causing a certain water content is added directly to seeds and the seeds are allowed to absorb water while flowing the plant seeds in a vessel such as a drum and the like, a method in which plant seeds are immersed in water for a certain time to cause water absorption, a method in which water is absorbed in a gel or porous carrier, then, the carrier is allowed to contact plant seeds to make the plant seeds to absorb water; and the like. As the water absorption treatment conditions, for example, treatment temperatures such as a constant temperature of about 2° C. to about 40° C., or alternating temperatures and the like, and treatment times of about 0.3 hours to about 14 days, and the like are mentioned.

### EXAMPLES

The present invention will be illustrated further in detail by examples such as production examples, test examples and the like below, but the present invention is not limited to these examples.

### Production Example 1

10 g of lettuce seeds (brand: Aztec, manufactured by Sumika Agrotech Co., Ltd.) were immersed in 40 ml (pH 3.6) of an aqueous solution containing 0.5 ppm of kinetin and 10 ppm of Ethrel 10 (formulation containing ethephone in a proportion of 10% as an active ingredient) as the active ingredient concentration, and a low temperature contact process was carried out. For other conditions, treatments in the processes of the germination improving method of the present invention were carried out under given treatment conditions (treatment temperature and treatment time) described in Table 1. During the immersion treatment in the low temperature contact process, the above-described plant seeds were stirred by air being supplied from a lower portion of the aqueous solution in which the plant seeds were immersed.

After the above-described treatment, the resultant plant seeds were washed with flowing water for 1 minute. The washed plant seeds were placed in a woven wire tray, and the excess water was removed from the plant seeds, then, the plant seeds were dried for 60 minutes while supplying air from the bottom part of the woven wire tray, obtaining dried plant seeds having a seed water content of 20% or less. The temperature of the air to be supplied in the drying process was controlled so that the surface temperature of the seeds was kept at in the range of 10° C. to 35° C., by ON/OFF of a heating apparatus equipped on the apparatus for supplying air. Thus obtained dried plant seeds were pelletized to a particle size of 3 mm by a dish-shaped rotary glanulator using, as a pelletizing material, a mixed powder of attapulgite and calcium stearate (weight ratio: attapulgite 9: calcium stearate 1) and water. The pelletized plant seeds were dried in a ventilation drying machine set at 35° C. until reaching a seed water content of 5%, obtaining dried pelletized seeds.

TABLE 1

| | Treatment condition | | Treatment condition | | Sum of |
|---|---|---|---|---|---|
| | in low temperature | | in low temperature | | treatment |
| | contact process | | preservation process | | times in both |
| | Temperature | Time | Temperature | Time | processes |
| | (° C.) | (hr) | (° C.) | (hr) | (hr) |
| Example 1 | 3 | 16 | — | — | 16 |
| Example 2 | 6 | 16 | — | — | 16 |
| Example 3 | 9 | 16 | — | — | 16 |
| Example 4 | 3 | 23 | — | — | 23 |
| Example 5 | 6 | 23 | — | — | 23 |
| Example 6 | 9 | 23 | — | — | 23 |
| Example 7 | 3 | 9 | 3 | 7 | 16 |
| Example 8 | 6 | 9 | 6 | 7 | 16 |
| Example 9 | 9 | 9 | 9 | 7 | 16 |
| Example 10 | 3 | 16 | 3 | 7 | 23 |
| Example 11 | 6 | 16 | 6 | 7 | 23 |
| Example 12 | 9 | 16 | 9 | 7 | 23 |
| Comparative | — | — | — | — | 0 |
| Example 1 | | | | | |
| Comparative | 15 | 8 | — | — | 8 |
| Example 2 | | | | | |
| Comparative | 12 | 16 | — | — | 16 |
| Example 3 | | | | | |
| Comparative | 15 | 16 | — | — | 16 |
| Example 4 | | | | | |
| Comparative | 12 | 23 | — | — | 23 |
| Example 5 | | | | | |
| Comparative | 15 | 23 | — | — | 23 |
| Example 6 | | | | | |
| Comparative | 3 | 27 | — | — | 27 |
| Example 7 | | | | | |
| Comparative | 9 | 27 | — | — | 27 |
| Example 8 | | | | | |
| Comparative | 3 | 40 | — | — | 40 |
| Example 9 | | | | | |
| Comparative | 9 | 40 | — | — | 40 |
| Example 10 | | | | | |
| Comparative | 15 | 16 | 3 | 7 | 23 |
| Example 11 | | | | | |
| Comparative | 15 | 16 | 9 | 7 | 23 |
| Example 12 | | | | | |
| Comparative | 15 | 16 | 3 | 24 | 40 |
| Example 13 | | | | | |
| Comparative | 15 | 16 | 9 | 24 | 40 |
| Example 14 | | | | | |
| Comparative | 15 | 16 | 3 | 72 | 88 |
| Example 15 | | | | | |
| Comparative | 15 | 16 | 9 | 72 | 88 |
| Example 16 | | | | | |
| Comparative | 3 | 16 | 3 | 11 | 27 |
| Example 17 | | | | | |
| Comparative | 9 | 16 | 9 | 11 | 27 |
| Example 18 | | | | | |
| Comparative | 3 | 16 | 3 | 24 | 40 |
| Example 19 | | | | | |
| Comparative | 9 | 16 | 9 | 24 | 40 |
| Example 20 | | | | | |

Thus obtained dried pelletized seeds were subjected to a germination test on a petri dish according to the rule of International Seed Testing Association. Evaluation in terms of germination rate in the germination test was carried out based on the germination rate on day 2 under conditions of high temperature and no light (30° C., dark condition) which are not suitable for germination of lettuce seeds. The examination of the germination rate (%) was carried out on dried pelletized seeds immediate after processing, after preservation at 30° C. for 1 year, and after preservation at 30° C. for 2 years. The results are shown in Table 2.

As apparent from Table 2, the germination rates in the scope of the present invention (namely, Examples 1 to 12) showed remarkably excellent results (that is, higher germination rates) than the germination rates in the range of comparative examples (namely, Comparative Examples 1 to 20), confirming the effect of the germination improving method of the present invention.

Further, as apparent from Table 2, the sustention of the germination ability after preservation for a long period of time in the scope of the present invention showed remarkably excellent results (that is, higher germination ratios in long period preservation) than the sustention of the germination ability after preservation for a long period of time in the range of comparative examples, confirming the effect of the germination improving method of the present invention.

TABLE 2

| | Germination rate (%) | | |
|---|---|---|---|
| | Immediately | After preservation | After preservation |
| Seeds | after | at 30° C. for | at 30° C. for |
| tested | processing | 1 year | 2 years |
| Example 1 | 80 | 82 | 85 |
| Example 2 | 88 | 91 | 91 |
| Example 3 | 92 | 94 | 92 |
| Example 4 | 85 | 86 | 86 |
| Example 5 | 92 | 95 | 94 |
| Example 6 | 97 | 95 | 92 |
| Example 7 | 87 | 88 | 87 |
| Example 8 | 94 | 94 | 96 |
| Example 9 | 97 | 95 | 95 |
| Example 10 | 87 | 90 | 90 |
| Example 11 | 98 | 97 | 94 |
| Example 12 | 98 | 96 | 93 |
| Comparative | 0 | 0 | 0 |
| Example 1 | | | |
| Comparative | 34 | 45 | 50 |
| Example 2 | | | |
| Comparative | 55 | 48 | 44 |
| Example 3 | | | |
| Comparative | 37 | 30 | 27 |
| Example 4 | | | |
| Comparative | 68 | 45 | 38 |
| Example 5 | | | |
| Comparative | 53 | 44 | 20 |
| Example 6 | | | |
| Comparative | 88 | 72 | 61 |
| Example 7 | | | |
| Comparative | 93 | 68 | 46 |
| Example 8 | | | |
| Comparative | 73 | 41 | 25 |
| Example 9 | | | |
| Comparative | 69 | 27 | 14 |
| Example 10 | | | |
| Comparative | 64 | 60 | 53 |
| Example 11 | | | |
| Comparative | 70 | 60 | 44 |
| Example 12 | | | |
| Comparative | 88 | 75 | 56 |
| Example 13 | | | |
| Comparative | 86 | 70 | 50 |
| Example 14 | | | |
| Comparative | 82 | 59 | 40 |
| Example 15 | | | |
| Comparative | 81 | 38 | 17 |
| Example 16 | | | |
| Comparative | 90 | 80 | 65 |
| Example 17 | | | |
| Comparative | 94 | 77 | 62 |
| Example 18 | | | |
| Comparative | 92 | 78 | 57 |
| Example 19 | | | |
| Comparative | 90 | 76 | 53 |
| Example 20 | | | |

### Production Example 2

10 g of lettuce seeds (brand: Aztec, manufactured by Sumika Agrotech Co., Ltd.) were immersed in 40 ml (pH 5.2) of an aqueous solution containing 2 ppm of gibberellin and 0.3% (w/v) of potassium nitrate, and a low temperature contact process was carried out. For other conditions, treatments in the processes of the germination improving method of the present invention were carried out under given treatment conditions (treatment temperature and treatment time) described in Table 3. During the immersion treatment in the low temperature contact process, the above-described plant seeds were stirred by air being supplied from a lower portion of the aqueous solution in which the plant seeds were immersed.

After the above-described treatment, the resultant plant seeds were washed with flowing water for 1 minute. The washed plant seeds were placed in a woven wire tray, and the excess water was removed from the plant seeds, then, the plant seeds were dried for 60 minutes while supplying air from the bottom part of the woven wire tray, obtaining dried plant seeds having a seed water content of 20% or less. The temperature of the air to be supplied in the drying process was controlled so that the surface temperature of the seeds was kept at in the range of 10° C. to 35° C., by ON/OFF of a heating apparatus equipped on the apparatus for supplying air. Thus obtained dried plant seeds were pelletized to a particle size of 3 mm by a dish-shaped rotary glanulator using, as a pelletizing material, a mixed powder of attapulgite and calcium stearate (weight ratio: attapulgite 9: calcium stearate 1) and water. The pelletized plant seeds were dried in a ventilation drying machine set at 35° C. until reaching a seed water content of 5%, obtaining dried pelletized seeds.

TABLE 3

| | Treatment condition | | Treatment condition | | Sum of |
|---|---|---|---|---|---|
| | in low temperature | | in low temperature | | treatment |
| | contact process | | preservation process | | times in both |
| | Temperature | Time | Temperature | Time | processes |
| | (° C.) | (hr) | (° C.) | (hr) | (hr) |
| Example 13 | 3 | 16 | — | — | 16 |
| Example 14 | 9 | 16 | — | — | 16 |
| Example 15 | 3 | 23 | — | — | 23 |
| Example 16 | 9 | 23 | — | — | 23 |
| Example 17 | 3 | 9 | 3 | 7 | 16 |
| Example 18 | 9 | 9 | 9 | 7 | 16 |
| Example 19 | 3 | 16 | 3 | 7 | 23 |
| Example 20 | 9 | 16 | 9 | 7 | 23 |
| Comparative | — | — | — | — | 0 |
| Example 1 | | | | | |
| Comparative | 12 | 8 | — | — | 8 |
| Example 21 | | | | | |
| Comparative | 12 | 16 | — | — | 16 |
| Example 22 | | | | | |
| Comparative | 12 | 23 | — | — | 23 |
| Example 23 | | | | | |
| Comparative | 3 | 27 | — | — | 27 |
| Example 24 | | | | | |
| Comparative | 9 | 27 | — | — | 27 |
| Example 25 | | | | | |
| Comparative | 15 | 16 | 3 | 7 | 23 |
| Example 26 | | | | | |
| Comparative | 15 | 16 | 9 | 7 | 23 |
| Example 27 | | | | | |
| Comparative | 15 | 16 | 3 | 72 | 88 |
| Example 28 | | | | | |
| Comparative | 15 | 16 | 9 | 72 | 88 |
| Example 29 | | | | | |
| Comparative | 3 | 16 | 3 | 24 | 40 |
| Example 30 | | | | | |
| Comparative | 9 | 16 | 9 | 24 | 40 |
| Example 31 | | | | | |

Thus obtained dried pelletized seeds were subjected to a germination test on a petri dish according to the rule of International Seed Testing Association. Evaluation in terms of germination rate in the germination test was carried out based on the germination rate on day 2 under conditions of high temperature and no light (30° C., dark condition) which are not suitable for germination of lettuce seeds. The examination of the germination rate (%) was carried out on dried pelletized seeds immediate after processing, after preservation at 30° C. for 1 year, and after preservation at 30° C. for 2 years. The results are shown in Table 4.

As apparent from Table 4, the germination rates in the scope of the present invention (namely, Examples 13 to 20) showed remarkably excellent results (that is, higher germination rates) than the germination rates in the range of comparative examples (namely, Comparative Examples 1, 21 to 31), confirming the effect of the germination improving method of the present invention.

Further, as apparent from Table 4, the sustention of the germination ability after preservation for a long period of time in the scope of the present invention showed remarkably excellent results (that is, higher germination rates in long period preservation) than the sustention of the germination ability after preservation for a long period of time in the range of comparative examples, confirming the effect of the germination improving method of the present invention.

TABLE 4

| | Germination rate (%) | | |
|---|---|---|---|
| | Immediately | After preservation | After preservation |
| Seeds | after | at 30° C. for | at 30° C. for |
| tested | processing | 1 year | 2 years |
| Example 13 | 77 | 80 | 80 |
| Example 14 | 86 | 86 | 88 |
| Example 15 | 84 | 88 | 87 |
| Example 16 | 90 | 90 | 88 |
| Example 17 | 86 | 88 | 87 |
| Example 18 | 93 | 93 | 90 |
| Example 19 | 86 | 82 | 85 |
| Example 20 | 93 | 90 | 89 |
| Comparative | 0 | 0 | 0 |
| Example 1 | | | |
| Comparative | 30 | 41 | 48 |
| Example 21 | | | |
| Comparative | 49 | 43 | 39 |
| Example 22 | | | |
| Comparative | 68 | 45 | 35 |
| Example 23 | | | |
| Comparative | 88 | 70 | 59 |
| Example 24 | | | |
| Comparative | 92 | 72 | 47 |
| Example 25 | | | |
| Comparative | 65 | 63 | 54 |
| Example 26 | | | |
| Comparative | 72 | 65 | 50 |
| Example 27 | | | |
| Comparative | 80 | 65 | 50 |
| Example 28 | | | |
| Comparative | 78 | 42 | 20 |
| Example 29 | | | |
| Comparative | 85 | 68 | 37 |
| Example 30 | | | |
| Comparative | 90 | 55 | 26 |
| Example 31 | | | |

### INDUSTRIAL APPLICABILITY

According to the present invention, a method of improving germination of plant seeds which is different from conventionally known methods of improving germination of plant seeds can be provided, for spreading choice on usable methods and enhancing production efficiency.

1. A method of improving germination of plant seeds, comprising a low temperature contact process of allowing plant seeds to contact plant growth regulating agents and water at a temperature lower than 10° C. wherein the treatment time in the low temperature contact process is shorter than 24 hours.

2. A method of improving germination of plant seeds, comprising
(1) a low temperature contact process of allowing plant seeds to contact plant growth regulating agents and water at a temperature lower than 10° C., and
(2) a low temperature preservation process of preserving, after said contact process, said plant seeds at a temperature lower than 10° C.,
wherein the sum of the treatment time in the low temperature contact process and the treatment time in the low temperature preservation process is shorter than 24 hours.

3. The method according to claim 2, wherein regarding the proportion of the treatment time in the low temperature contact process and the treatment time in the low temperature preservation process, the value of the latter is less than 2 with respect to a value of the former of 1.

4. The method according to any one of claims 1 to 3, wherein the plant growth regulating agent are auxin, cytokinin, gibberellin, abscisic acid or ethylene generating agent.

5. The method according to claim 1 or 2, wherein the low temperature contact process is a process of allowing plant seeds to contact plant growth regulating agents and water while aerating.

6. Plant seeds which have been subjected to the method as described in claim 1 or 2.

7. A method of producing dry plant seeds maintaining excellent germination rate, comprising
(1) a low temperature contact process of allowing plant seeds to contact plant growth regulating agents and water at a temperature lower than 10° C., and
(2) a drying process of drying, after said contact process, said plant seeds to a seed water content of 10% or less,
wherein the treatment time in the low temperature contact process is shorter than 24 hours.

8. A method of producing dry plant seeds maintaining excellent germination rate, comprising
(1) a low temperature contact process of allowing plant seeds to contact plant growth regulating agents and water at a temperature lower than 10° C.,
(2) a low temperature preservation process of preserving, after said contact process, said plant seeds at a temperature lower than 10° C., and
(3) a drying process of drying, after said preservation process, said plant seeds to a seed water content of 10% or less,
wherein the sum of the treatment time in the low temperature contact process and the treatment time in the low temperature preservation process is shorter than 24 hours.

9. The method according to claim 8, wherein regarding the proportion of the treatment time in the low temperature contact process and the treatment time in the low temperature preservation process, the value of the latter is less than 2 with respect to a value of the former of 1.

10. The method according to claim 7 or 8, wherein the low temperature contact process is a process of allowing plant seeds to contact plant growth regulating agents and water while feeding air.

11. Dry plant seeds which have been produced by the method as described in claim 7 or 8.

12. Plants obtained by germination of the plant seeds as described in claim 6, and further raising seedling thereof.

13. Plants obtained by germination of the plant seeds as described in claim 11, and further raising seedling thereof.
